(19) United States
(12) Patent Application Publication
(10) Pub. No.: US 2025/0191035 A1
(43) Pub. Date: Jun. 12, 2025

(54) Method and system, for comparison of real-estate data

(71) Applicant: Jody R Massey, Atlanta, GA (US)

(72) Inventor: Jody Russell Massey, Atlanta, GA (US)

(73) Assignee: Jody R Massey, Atlanta, GA (US)

(21) Appl. No.: 18/535,270

(22) Filed: Dec. 11, 2023

(51) Int. Cl. G06Q 30/02; G06F 40/279; G06Q 30/0283; G06Q 50/16

(52) U.S. Cl. CPC G06Q 30/0278; G06F 40/279; G06Q 30/0283; G06Q 50/16

(57) ABSTRACT

A method and system, for comparison of real-estate data, comprising the steps as iterated, hereafter. Receiving inputs from a user with respect to a property, in order to obtain real-estate data. Processing the real-estate data, to obtain a plurality of issue-categories. Calculating a frequency of service orders within each of the issue-categories. Generating a plurality of comparative datasets, by comparing the frequency of service orders for each issue-category, of the property, with respect to, an average property with similar attributes, wherein the average property is obtained from a plurality of real-estate data-sources. Reviewing and presenting to the user, all the recurring issue-categories, within each of the plurality of comparative datasets, as a first output.

### FIELD OF THE INVENTION

The present subject matter relates to, a method and system, in order to compare real-estate data. More specifically to compare real-estate data that is comprising of, but not limited to, service orders, maintenance, repairs and other related historical data, of a user desired real-estate or property.

### BACKGROUND OF THE INVENTION

Known methods and systems that, provide real-estate data comparison, have several drawbacks and disadvantages such as but not limited to, they do not compare aspects relating to service orders, maintenance, repairs and other related historical data, failure to categorize the real-estate data based on such aspects, no analysis of the frequency of such issues within each category, recurring issues in the categories are not highlighted, and many other well-known drawbacks within this domain. Especially, such a comparison of the aforementioned aspects with respect to the aspects of an average property, is not conducted by known methods and systems of real-estate data comparison, in order to specifically compare these aspects, with respect to a virtual data-generated average property.

The drawbacks as disclosed above that, known methods and systems, do not compare aspects relating to service orders, maintenance, repairs and other related historical data, is a major disadvantage as users are unable to compare such data, in real-time if desired. Further, the failure to categorize such aspects into specific data-based issue categories, leaves the user with no access to be able to analyse such data. Furthermore, there is no analysis conducted as to the frequency of occurrence of such issues within each category. Moreover, recurring issues in each category are not highlighted for quick-access by a user.

Beyond the above drawbacks, there are several other short-comings of known methods of comparison. For instance, real-estate data obtained from one source, is not analysed as explained in the previous paragraph, which may be further compared against the analysed data obtained from a different source, to identify if there is an overlap of any of the issue categories, amongst the data obtained from the various real-estate data sources. More specifically, an engineering review of the recurring issues and overlaps of these recurring issues is not conducted, in order to identify potential high-risk issue-categories. Particularly, prediction/forecast of future cost-estimate for conducting maintenance/repairs based on all the above parameters/data is not accomplished by any known system or method of comparison, for real-estate data.

The purpose of the present subject matter presented below, is particularly to provide a simple, economic, swift and efficient solution to the all the above described drawbacks and short-comings within the art, in order to, at least partially overcome most of the above-mentioned disadvantages.

### SUMMARY OF THE INVENTION

The present subject matter relates to, a method and system, for comparison of real-estate data, comprising the steps as iterated, hereafter. Receiving inputs from a user with respect to a property, in order to obtain real-estate data. Processing the real-estate data, to obtain a plurality of issue-categories. Calculating a frequency of service orders within each of the issue-categories. Generating a plurality of comparative datasets, by comparing the frequency of service orders for each issue-category, of the said property, with respect to, an average property with similar attributes, wherein the average property is obtained from a plurality of real-estate data-sources. Reviewing and presenting to the user, all the recurring issue-categories, within each of the plurality of comparative datasets, as a first output.

The present subject matter relates to, a method and system, for comparison of real-estate data, comprising the steps of, receiving inputs from a user with respect to a property, in order to obtain real-estate data, processing the real-estate data using a textual-analysis process followed by an internal proprietary logic in order to obtain a plurality of issue-categories. After that, calculating a frequency of service orders within each of these issue-categories, generating a plurality of comparative datasets by comparing the frequency of service orders for each issue-category of the said property with respect to an average property with similar attributes, wherein the average property is obtained from a plurality of real-estate data-sources and reviewing all the recurring issue-categories, within each of the plurality of comparative datasets, as a first output.

In other embodiment of the present subject matter relates to, a method and system, for comparison of real-estate data, further comprising the steps of, comparing and presenting, the recurring issue-categories obtained from one real-estate data-source, with respect to, another real-estate data-source, in order to identify an overlap in the recurring issue-categories, as a second output.

In another embodiment of the present subject matter relates to, a method and system, for comparison of real-estate data, further comprising the steps of, conducting an Engineering-Review of the recurring issue-categories and the identified overlaps in the recurring issue-categories, in order to determine one or more issue-categories that are at high-risk, as a third output.

In yet another embodiment of the present subject matter relates to, a method and system, for comparison of real-estate data, further comprising the steps of, analysing all the previous three outputs, in order to form analysed-data. Based on this analysed-data, predicting and/or forecasting a precise or accurate cost-estimate, for conducting repairs/maintenance of the said property in the future, as a fourth output. Further on, an additional step comprises, presenting the entirety of the analysed-data and the fourth output, in an intelligible sentence-form to the user.

In some embodiments of the present subject matter relates to, a method and system, for comparison of real-estate data wherein, the real-estate data including the average property, is obtained from a plurality of real-estate data-sources, that are selected from the group consisting of various public/non-public data-sources, such as but not limited to, building owners, general ledgers, capital plans, budgets, service order records/requests, online reviews, internal review, capex and any of the combinations thereof.

In some embodiments of the present subject matter relates to, a method and system, for comparison of real-estate data wherein, the plurality of issue categories, are selected from the group consisting of categories, such as relating to, Roofing, Plumbing (Water Leak in Utility Closet, Plumbing Fixture Leaks, Sewer Smell, Water Leaks Behind Sheetrock, Leaking Water Heaters, Toilet Not Flushing, Fixtures That Are In Poor Condition, No Hot Water, Low or No Water Pressure, etc.), Piping (Sanitary Not Draining, Below Ground Sanitary, etc.), Air Conditioning (Humidity/Mold, Heating Not Working, AC Not Working Properly, Thermostat Issues, Smell In HVAC, Miscellaneous HVAC, Fan Issues, HVAC Drip or Leak, Unbalanced HVAC, Inadequate HVAC capacity, etc.), Electrical/Fire related, Window/Glass related (Window Leak, Windows Fogged, Window Condensation, etc.), Appliances (Washer/Dryer Issues, Dishwasher Issues, etc.), or any other similar real-estate issue, as known within the field.

In some embodiments of the present subject matter relates to, a method and system, for comparison of real-estate data wherein, the plurality of issue-categories are processed by the internal proprietary logic for obtaining both typical as well as non-typical, types of issue-categories. Further, in some other embodiments of the present subject matter relates to, a method and system, for comparison of real-estate data wherein, the internal proprietary logic reviews all the issue-categories obtained for any errors/mistakes, and in case, errors/mistakes are identified a correction to the issue-categories is made by the internal proprietary logic. Furthermore, in yet some other embodiments of the present subject matter relates to, a method and system, for comparison of real-estate data wherein, the internal proprietary logic determines the cause of error/mistake, then based on this cause it makes modifications to the internal proprietary logic and further re-calculates entire available data based on the modified logic, to ensure that all similar mistakes/errors are eliminated.

In some embodiments of the present subject matter relates to, a method and system, for comparison of real-estate data wherein, the textual-analysis process is applied on the obtained real-estate data, before the internal proprietary logic processes them into the plurality of issue categories, wherein the textual-analysis process identifies spelling-mistakes/abbreviations/truncations within the obtained real-estate data and predicts last-words as well as provides textual-solutions for other identified textual-discrepancies within the obtained real-estate data, using Natural Language Models.

The present subject matter provides significant advantages compared to other known methods/systems of real-estate data comparison, as it provides many benefits such as but not limited to, comparing aspects relating to service orders, maintenance, repairs and other related historical data, categorization of real-estate data based on such aspects, analysis of the frequency of such issues within each category, identification of recurring issues in the categories, and overcomes many other well-known drawbacks within this domain.

The benefits of the methods/systems, disclosed by the present subject matter in other words, compares aspects relating to service orders, maintenance, repairs and other related historical data, which provides a major insight to the users by comparing such data in real-time if desired. Further, the categorization of such aspects/issues into specific data-based issue-categories, allows the user with accessibility to quickly analyse such data. Furthermore, analysis is conducted with respect to the frequency of occurrence of such issues within each category. Moreover, recurring issues in each category are also highlighted for quick-access by a user. All these as well as other features of the present method, provide a definite and distinct way of analysing and disseminating of information, based on specific data-analysis of any real-estate and/or property data, with respect to a market-based average, based on such aspects/parameters, as described above, compared to known methods available currently.

Beyond the above advantages, there are several other benefits as disclosed within the present subject matter, when the disclosed method and system, for comparison of real-estate data is applied. For instance, real-estate data obtained from one source, is analysed as explained in the previous paragraph, which may then be further compared against the analysed data obtained from a different source, in order to identify if there is an overlap of any of the issue categories, amongst the data obtained from the various real-estate data sources. More specifically, an engineering review is conducted for the recurring issues and overlaps, in order to identify potential high-risk categories. Particularly, a prediction/forecast of future cost-estimate for conducting maintenance/repairs based on all the above data is not accomplished by any known system or method of comparison, for real-estate data. Finally, presenting the entirety of the analysed data, in a digestible, actionable and intelligible sentence-form to the user, allowing even a user with no technical experience, to be able to gain expert-level insights from the comparison-analysis of the real-estate data.

For purposes of summarizing the invention and the advantages achieved over the prior art, certain objects and advantages of the invention have been described above. Of course, it is to be understood that not necessarily all such objects or advantages may be achieved in accordance with any one particular embodiment of the invention. Thus, for example, those skilled in the art will recognize that each embodiment of the invention, may be embodied or carried out, in a manner that achieves or optimizes, one advantage or a group of advantages.

Various sub-methods and/or additional processes, are claimed in the independent/dependent claims, these embodiments may be, combined, or, applied separately, with respect to each other. To the accomplishment of the foregoing and related ends, certain illustrative aspects of the disclosed innovation are described herein, in connection with the following description and the annexed drawings. These aspects are indicative, however, of but a few of the various ways in that the principles disclosed herein may be employed and are intended to include all such aspects and their equivalents. Other advantages/applications and novel/inventive features will become apparent from the following detailed description when considered in conjunction with the drawings/illustrations provided.

### BRIEF DESCRIPTION OF THE DRAWINGS

The summary above, as well as the following detailed description of illustrative embodiments, is better understood when read in conjunction with the appended drawings/figures. For the purpose of illustrating the present subject matter, exemplary illustrations of the subject matter are depicted within these drawings. However, the present subject matter is not limited to specific methods and instrumentalities disclosed herein. Moreover, those in the art will understand that the drawings are not to scale/inclusive of all essential components/elements.

Embodiments of the present subject matter will now be described, by way of example only, with reference to the following Drawings/figures, wherein:

FIG. 1 depicts a schematic view of a method/system 100 for obtaining a first output.

FIG. 2 depicts a schematic view of a method/system 200 for obtaining a second output.

FIG. 3 depicts a schematic view of a method/system 300 for obtaining a third output.

FIG. 4 depicts a schematic view of a method/system 400 for obtaining a fourth output.

FIG. 5 depicts a schematic block-diagram of a method/system 500.

In the accompanying drawings, an underlined number is employed to represent an item over that the underlined number is positioned, or, an item to that the underlined number is adjacent. A non-underlined number relates to an item identified by a line linking the non-underlined number to the item. When a number is non-underlined and accompanied by an associated arrow, the non-underlined number is used to identify a general item, at that the arrow is pointing to.

### DETAILED DESCRIPTION

The features and advantages of the present subject matter, just as they are stated in the claims, will now be described in detail with reference to the appended drawings, showing several examples of deployment configurations/embodiments for the present invention.

The present subject matter relates to, a method/system for comparison of real-estate data, comprising the steps as iterated, hereafter. Receiving inputs from a user with respect to a property, in order to obtain real-estate data. Processing the real-estate data, to obtain a plurality of issue-categories. Calculating a frequency of service orders within each of the issue-categories. Generating a plurality of comparative datasets, by comparing the frequency of service orders for each issue-category, of the said property, with respect to, an average property with similar attributes, wherein the average property is obtained from a plurality of real-estate data-sources. Reviewing and presenting to the user, all the recurring issue-categories, within each of the plurality of comparative datasets, as a first output. Further, comparing and presenting, the recurring issue-categories obtained from one real-estate data-source, with respect to, another real-estate data-source, in order to identify an overlap in the recurring issue-categories, as a second output. Furthermore, conducting an Engineering-Review of the recurring issue-categories and the identified overlaps in the recurring issue-categories, in order to determine one or more issue-categories that are at high-risk, as a third output. Moreover, analysing all the previous three outputs, in order to form an analysed data-set or analysed-data. Based on this analysed data, predicting and/or forecasting a precise or accurate cost-estimate, for conducting repairs/maintenance of the said property in the future, as a fourth output. Lastly, an additional step comprises, presenting the entirety of the analysed-data and the fourth output, in an intelligible sentence-form to the user, for simplifying the analysed-data as well as increasing ease of access to the analysed-data, for all users regardless of their technical prowess.

In the case, where there are two or more definitions of a term that is used and/or accepted within the known art, the definition of the term as used herein, is intended to include all such meanings unless explicitly stated to the contrary.

For purposes of the detailed description of the preferred embodiments, the following definitions are used:

Throughout the present subject matter, the term “user” is referring to any property buyer/renter, owner, sales agent, marketer/promoter, operator, builder, architect, engineer, or the like, such as any homo-sapien/human who is interested in obtaining a detailed and accurate assessment of a property.

Throughout the present subject matter, the term “property” or “properties” refers to any real-estate unit. Property includes, but is not limited to any, house, building, villa, apartment, mansion, chalet, resort, plant, workshop, shop, cubicle, office-space, venue, hall, other constructions/infrastructures, any human-dwelling, or the like, as is known within the art.

Throughout the present subject matter, the term “real-estate data” is referring to any and all kind of information/data, regardless of the depth of details, relating to a property or real estate unit. This real-estate data, comprises of, but not limited to, age, location, area, restrictions, amenities, sale price (old, current and/or predicted), construction cost, connectivity with public utilities, convenience, plumbing data, electrical data, builder/constructor data, service orders/requests, repairs/maintenance, historical data, reviews/comments regarding the property from repairmen, service men, builders, tenants, internal assessments, etc. regarding the property, or the like, as is known within the art. Further, this real-estate data in some embodiments may even amount to more than 5000 lines of data/information, with over 15000 data-points that are utilised for categorization, of this real-estate data for any given property.

Throughout the present subject matter, the term “real-estate data-sources” refers to a plurality of data-sources, that are known or otherwise, from where the real-estate data is obtained. These data-sources may comprise, various public/non-public data-sources, such as but not limited to, building owners, general ledgers, capital plans, budgets, service order records/requests, online reviews, internal reviews, capex and any of the combinations thereof. The non-public sources may further include, but not limited to, specifically conducted, calls, interviews or actual-observations of some of the properties in real-time, for some instances.

Throughout the present subject matter, the term “textual-analysis process” is referring to the process of identification, sanitization and normalization of textual-discrepancies within the obtained real-estate data, using programmes/algorithms based on Natural Language Models. The textual-discrepancies includes, but are not limited to, spelling-mistakes, abbreviations, word-truncations, mis-spelled words, and other known discrepancies of similar nature. Further, the information from a real-estate data source may be incomplete, due to space constraints or other reasons, where many of the words or sometimes entire sentences may be missing/omitted, in such cases context-based algorithms/programmes are utilised. Hence, the textual-analysis process identifies, sanitizes and normalizes all such textual discrepancies and incomplete instances within the obtained raw-data from the various real-estate data-sources, to provide a clean-set of real-estate data to an internal proprietary logic for further processing.

Throughout the present subject matter, the term “internal proprietary logic” refers to the processing algorithm or program, that categorizes the clean-set of real-estate data obtained from the textual-analysis process into, various typical or non-typical categories. These categories specifically being issue-categories, that outline/detail all the possible specific problems, issues, repairs, maintenance needs and/or dangers/hazards, relating to the property requested by the user. Further, the typical issue-categories may be pre-defined/standardised categories, that are available for almost all types of properties, such as for e.g. issues within plumbing, electrical, etc. Furthermore, the non-typical categories may be real-time/specific issue-categories, that are identified specifically for that particular property and is not a common feature or issue-category for most properties, essentially unique issues, such as for e.g. issues with elevators, swimming pool issues, terrace garden related issues, Issue with the chandelier, stained-glass window issues, etc. Moreover, the internal proprietary logic, comprises of human-coded algorithms/programs, as well as, several other data-processing programs that are based on deep-learning, machine-learning, artificial-intelligence, neural-networks, reinforced machine learning, or other algorithms of the like, that process the clean-set of real-estate data into the various issue-categories, on a case-by-case basis for each property. Moreover, the internal proprietary logic is responsible for conducting all review, identifications, determinations and analysis of the clean-set of real-estate data, in order to provide majorly four types of output. Lastly, the internal proprietary logic assesses the four types of outputs in order to present to the user, all essential pertinent data/information regarding the desired property, in an intelligible sentence-form.

Since the “internal proprietary logic” utilises, several segregated/un-segregated programming components/modules, in the form of various programmes and/or algorithms, the internal proprietary logic is capable of conducting a self-assessment of the issue-categories that are categorised and reviews the same for any mistakes/errors. In case, any errors/mistakes in categorization are identified, a correction is made by the internal proprietary logic, in order to rectify the mistake/error, and the category is properly assigned for the issue, in that instance. Further, the “internal proprietary logic” determines the cause of this error/mistake and based on this cause, the internal proprietary logic modifies the programs/algorithms that form the internal proprietary logic, in order to make sure the identified mistake/error is never repeated again, in future. This ensures that the internal proprietary logic, continuously increases the accuracy-level of the entire categorization process. Furthermore, the internal proprietary logic conducts a re-calculation and/or re-calibration process on the entirety of data that is at its disposal including all the real-estate data of all the properties at its disposal at that time, to rectify all similar mistakes/errors within the categorized real-estate data, of any other property or real-estate unit. Moreover, this process of re-calibration, is essential for avoiding error-duplication, wrong-categorization, etc., within all the unique datasets, generated and available to the system/method of comparison. This process of self-assessment and continuous automated error-rectification of the internal proprietary logic, ensures that the accuracy of the various outputs provided by the internal proprietary logic, keeps on increasing as time passes.

Throughout the present subject matter, the term “issue-category” or “issue-categories” refers to specific categories or sub-categories of issues, relating to a property or real-estate unit. The issue-categories, comprises but are not limited to categories/sub-categories of, roofing (flaking, cracking, leaks, dangers, awnings, etc.), walls (damages, discoloration, repairs, loss of integrity, etc.), structures such as, pillars, beams, girders, guardrails, bracing, anchoring components (deterioration, rusting, aging, bending, chipping, hazards, loss of integrity, etc.), plumbing (leakage, water leak in utility closet, plumbing fixture leaks, sewer smell, water leaks behind sheetrock, leaking water heaters, toilet not flushing, fixtures that are in poor condition, no hot water, low or no water pressure, etc.), piping (sanitary not draining, below ground sanitary, etc.), air conditioning (humidity/mold, heating not working, ac not working properly, thermostat issues, smell in HVAC, miscellaneous HVAC, fan issues, HVAC drip or leak, unbalanced HVAC, inadequate HVAC capacity, humidity troubles, etc.), electrical/fire related, window/glass related (window leak, windows fogged, window condensation, cracked/shattered/missing panes, etc.), appliances (washer/dryer issues, dishwasher issues, microwave/oven, refrigerator, etc.), any non-functioning amenity, any other potential hazard, or any other similar real-estate issue, as known within the art, that the user intends to know about. further in some embodiments of the present subject matter, the issue-categories are subdivided into a typical and non-typical issue-categories.

Throughout the present subject matter, the term “frequency of service-orders” or “frequency of service-requests” refers to the specific rate at which the service-orders/requests were raised and addressed, for any particular property for any one issue-category. This specific rate, may be identified as the total number of times the service-order was raised by a tenant/owner for that property. Further, in other instances the specific rate may be identified, based on the deviation of the sporadicity of the service-request, with respect to, an expected/estimated/average time-period for that specific type of service-request.

Throughout the present subject matter, the term “comparative datasets” is referring to specific kind of comparison data between, the user inputted property, with respect to, an average property. Specifically, the comparative dataset provides a comparison of frequency of service-orders/requests for each of the categorised issue-categories, between the user desired property and an average property.

Throughout the present subject matter, the term “average property” refers to an aggregated average value of all the similar property or real-estate unit, that are available within each real-estate data-source, having almost all the similar attributes, parameters, amenities and issues as the user desired property, that was initially inputted by the user. More specifically, it represents an average value of all the similar properties within a real-estate data-source to form a unique dataset that has been dubbed/defined in the present subject matter as an average property. This average property is obtained from each of the various different real-estate data sources, which provides a variance in the average property values with respect to each of the real-estate data source. Hence, real-estate data of plurality of different such average properties may be obtained, from each of these various real-estate data sources for the same user desired property. This comparison leads to a plurality of comparative datasets being obtained, when the frequency of service orders for the user desired property is compared with respect to the frequency of service-orders/requests within each of the plurality of average properties, that are obtained from the plurality of real-estate data-sources, as described above.

Throughout the present subject matter, the term “recurring issue-categories” is referring to the specific issue-categories that are recurring within each of the plurality of comparative datasets. In essence, all the issue categories for a user desired property, that are recurring significantly more than their average property counterparts, in order to compare the frequency of service order/requests within the comparative datasets. Based on this comparison data, all instances of issue-categories that have a higher frequency of service-orders for the user desired property with respect to the average property frequency, are considered to be recurring issue categories. For example, in some embodiments, the recurring issue-categories may be a top 5 to 20 issue-categories identified for the desired property, or, in some other embodiments, the recurring issue-categories could be issue-categories that were obtained purely from the average property data individually, regardless of the initial user desired property issue-categories. These recurring issue-categories form a first output.

Throughout the present subject matter, the term “overlap in the recurring issue-categories” refers to the specific overlap, of recurring issue-categories obtained from one real-estate data-source, with respect to, recurring issue-categories acquired from another real-estate data-source. This overlap in the recurring issue-categories, provides crucial information to the user that, the specific issue-category needs to be investigated more thoroughly, as it is deviation/occurrence is considerably more than expected, with respect to a plurality of average properties, in essence. This data forms a second output.

Throughout the present subject matter, the term “engineering review” is referring to a review process of the issue-categories that are either recurring issue-categories, or, are overlapping recurring issue-categories, in order to identify as well as determine, whether these specific issue-categories fall under a high-risk category/designation. The engineering review, may in some embodiments, entails manual (by a technical expert) or computer-assisted (internal proprietary logic), line-by-line review of the original real-estate data obtained from the various data-sources, in order to evaluate the actual inputs that lead up to the high-risk issue-categories, which have been determined by the internal proprietary logic based on the recurrence or overlaps of recurrence, as disclosed previously. Further, in some embodiments of the present subject matter, a physical inspection of the property or real-estate unit, may also be conducted by a technical specialist. Furthermore, in some other embodiments, new data/information may be remotely obtained, with respect to the issue-category in real-time, in order to assess the risk posed by the particular issue properly, with maximum accuracy. This forms a third output.

Throughout the present subject matter, the term “predicting/forecasting” refers to the process of estimating based on all the analysed data, regarding the future maintenance and/or repair costs of the property/real-estate unit, of interest. The prediction/forecasting uses all the details/information obtained from in the previous three outputs, in order to make a thorough detailed estimate of the future prospects and foreseeable issues, that will/may arise. This ensures that the user is appropriately alerted/notified regarding the desired real-estate unit, including but not limited to, all the pertinent information (costs, time-periods, complexity-levels, etc.) about all such possible repair/maintenance events in real-time, with maximum precision and accuracy. This enables a user to make a well-informed decision based on hard-evidence and analysis of the real-estate data, whether it is wise to proceed with acquiring/renting that particular property or real-estate unit, of interest.

Throughout the present subject matter, the term “central server” refers to a primary computing-platform where the textual-analysis process and the internal proprietary logic operate, in order to process the various inputs and outputs, described within the present subject matter. The method and system of comparison of real-estate data, uses the central server, in order to obtain input from a user device as well as public/non-public real-estate data-sources and after processing all the data, it presents the various outputs to the user device. Examples of user device includes, but not limited to, any handheld/wearable/desktop computing device, web-portal, website, software/mobile application, etc. having connectivity/access with/to the central server. Further, it would be obvious to a person skilled in the art that, the central server incorporates within it several known electronic and electrical components/architectures, in order for it to be capable of performing all the tasks and processes, as described in the present subject matter. Furthermore, it is reasonable to assume based on the current knowledge within the art that, such a central server may be accessible to the users, via a website or an application, on any user computing device.

Exemplary Embodiments of the system and method of comparing real-estate data are defined below

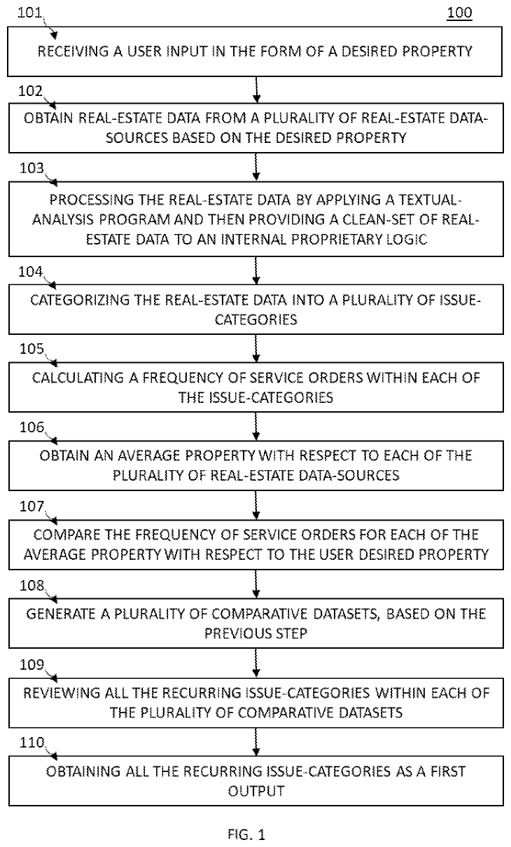

As disclosed within FIG. 1, of the present subject matter, a primary embodiment of the system and method of comparing real-estate data is disclosed. Specifically, FIG. 1 depicts a schematic view of a primary exemplary embodiment of a method 100 for executing upon request from a user, a comparison between the user desired property with all available real-estate data, in order to provide a list/data of recurring issue-categories for the desired property, as described herein.

In one exemplary embodiment of method of using the system for comparison of real-estate data 100, which comprises at least a central server having a textual analysis process and internal proprietary logic, that receives 101 a user input, in the form of a desired property that is of interest to the user. In any embodiments of the present subject matter, the user computing device may include but not limited to, any suitable user computing device, such as a smart-phone, tablet, laptop computing device, desktop computing device, wearable devices (e.g., “smart glasses,” “smart watch,” etc.), and/or any other user computing devices with access to the server. Upon receiving inputs from a user with respect to a desired property, the server obtains 102 real-estate data with respect to that property, from a plurality of real-estate data sources, including various public/non-public data-sources, such as but not limited to, building owners, general ledgers, capital plans, budgets, service order records/requests, online reviews, internal reviews, capex and any other similar data-source, as known within the art. The server then initiates processing 103 the real-estate data obtained by first applying a textual-analysis program for textual-sanitization of the obtained data to generate a clean-set of real-estate data. This clean-set of real-estate data is then provided to an internal proprietary logic for further processing the real-estate data. The clean-data is hence categorized 104 by the internal proprietary logic, in order to obtain a plurality of issue-categories with respect to the desired property. Specifically, the server then calculates 105, the frequency of service orders with respect to each of the plurality of issue-categories obtained in previous step. The server then proceeds to obtain an average property 106 with respect to the parameters, attributes and amenities of the desired property. This average property is an aggregation of real-estate data of several actual real-estate properties within each of the plurality of real-estate data-sources, that are processed by the server in order to generate each of the average property. In any embodiments of the present subject matter, these average properties contain an average estimation with respect to the frequency of service orders for each of the issue-categories detected/categorised within them, by the textual analysis process and the internal proprietary logic modules of the central server. Upon obtaining the above data the server compares 107 the frequencies of service orders for each of the average property with respect to the user desired property. For each of these comparisons that are conducted, a unique comparative dataset is generated by the internal proprietary logic, which primarily includes a comparison of the frequency of service orders between an average property issue-categories and the issue-categories of the user desired property. In this way, a plurality of comparative datasets is generated 108, by the server, based on each of the average property data, that is obtained from the plurality of different real-estate data-sources. A conclusive review 109 is conducted by the server to identify all the recurring issue-categories, within each of the plurality of comparative datasets. In any embodiments of the present subject matter, the recurring categories may include but not limited to the top percentile of issue-categories, or any other issue category that may have an unusually high frequency of service orders. These recurring issue categories are presented and acquired 110 by the server, as a first output to the user.

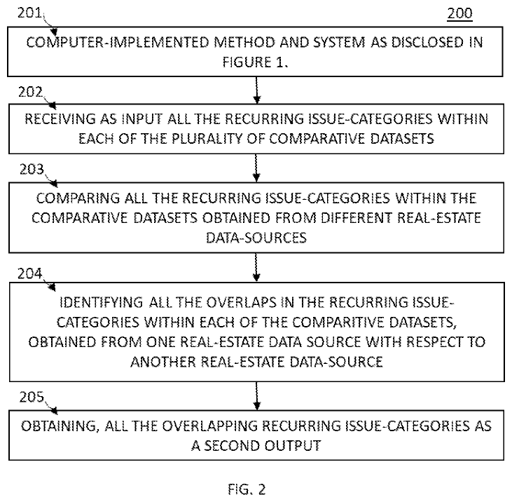

Further, as disclosed within FIG. 2, of the present subject matter, a secondary embodiment of the system and method of comparing real-estate data is disclosed. Specifically, FIG. 2 depicts a schematic view of a secondary exemplary embodiment of a method 200 for executing upon request from a user, a comparison between the user desired property with all available real-estate data, in order to provide a list/data of overlaps in recurring issue-categories for the desired property, as described herein.

In a second exemplary embodiment of method of using the system for comparison of real-estate data 200, which comprises at least a central server having a textual analysis process and internal proprietary logic, that receives a user input, in the form of a desired property that is of interest to the user. The method/system 100 as described in FIG. 1 of the present subject matter is followed by the server, encompassing the first step 201 of the method 200, in order to obtain as a first output, the recurring issue-categories as described previously. Pursuant to this, the server then receives 202 these recurring issue-categories as input for further processing all the obtained real-estate data. A comparison 203 is conducted by the internal proprietary logic of all the recurring issue-categories, that are obtained from/within one comparative dataset, with respect to each of the other comparative datasets. After which, the server identifies 204 all the overlapping recurring issue-categories, that are identified to be present in at least two or more comparative datasets. These overlaps in recurring issue-categories are presented and acquired 205 by the server, as a second output to the user.

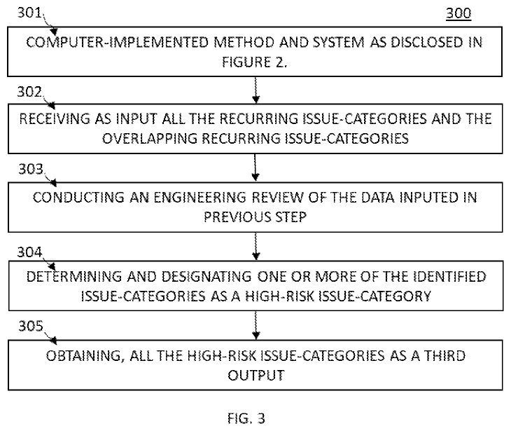

Furthermore, as disclosed within FIG. 3, of the present subject matter, a tertiary embodiment of the system and method of comparing real-estate data is disclosed. Specifically, FIG. 3 depicts a schematic view of a tertiary exemplary embodiment of a method 300 for executing upon request from a user, a comparison between the user desired property with all available real-estate data, in order to provide a list/data of all the high-risk issue-categories for the desired property, as described herein.

In a third exemplary embodiment of method of using the system for comparison of real-estate data 300, which comprises at least a central server having a textual analysis process and internal proprietary logic, that receives a user input, in the form of a desired property that is of interest to the user. The method/system 200 as described in FIG. 2 of the present subject matter is followed by the server, encompassing the first step 301 of the method 300, in order to obtain as a first and second output, the recurring issue-categories and the overlaps in the recurring issue-categories, respectively, as described previously. Pursuant to this, the server then receives 302 these recurring as well as, overlaps in the recurring issue-categories as input for further processing all the obtained real-estate data. Essentially, the first output and second output are considered as inputs for the next process. An engineering review 303 is conducted by the server, by employing the textual analysis process and the internal proprietary logic on all the real-estate data that leads upto, the recurring issue-categories and the overlaps in the recurring issue-categories, that are obtained from the previous steps. After which, the server determines and designates 304, one or more of the issue-categories reviewed in previous step as a high-risk issue-category, based on its review process. These high-risk issue-categories are presented and acquired 305 by the server, as a third output to the user.

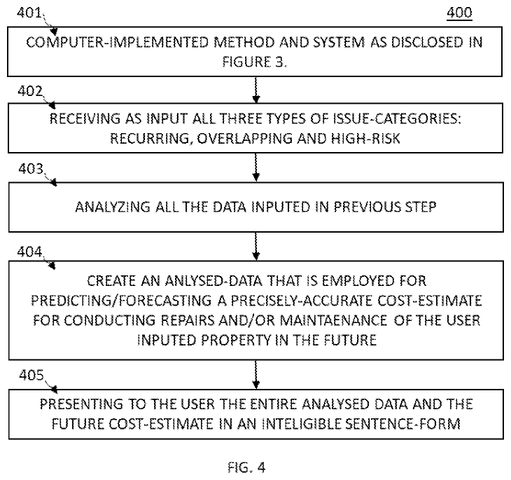

Moreover, as disclosed within FIG. 4, of the present subject matter, a quaternary embodiment of the system and method of comparing real-estate data is disclosed. Specifically, FIG. 4 depicts a schematic view of a quaternary exemplary embodiment of a method 400 for executing upon request from a user, a comparison between the user desired property with all available real-estate data, in order to provide a precisely-accurate prediction/forecast of all cost-estimates involved with conducting repairs/maintenance of the user desired property in future, as described herein.

In a fourth exemplary embodiment of method of using the system for comparison of real-estate data 400, which comprises at least a central server having a textual analysis process and internal proprietary logic, that receives a user input, in the form of a desired property that is of interest to the user. The method/system 300 as described in FIG. 3 of the present subject matter is followed by the server, encompassing the first step 401 of the method 400, in order to obtain as a first, second and third output, the recurring issue-categories, the overlaps in the recurring issue-categories and the high-risk issue-categories, respectively, as described previously. Pursuant to this, the server then receives 402 these recurring, overlaps in the recurring, as well as, high-risk, issue-categories as input for further processing all the obtained real-estate data. Essentially, the first output, second output and third output are all considered as inputs for the next process. An analysis 403 is conducted by the server, by employing the textual analysis process and the internal proprietary logic on all the real-estate data that leads upto, the recurring issue-categories, the overlaps in the recurring issue-categories and the high-risk issue-categories, that are obtained from the previous steps. After which, the server creates an analysed-data 404, which is employed for predicting and/or forecasting a precise as well as accurate cost-estimate for conducting repairs and/or maintenance of the user desired property, in the future. These predicted/forecasted cost-estimates are presented 405 by the server, as a fourth output to the user. In any of the embodiments of the present subject matter, the various outputs are processed by the server, in order to provide the user an output in an intelligible sentence-form, for ease of understanding.

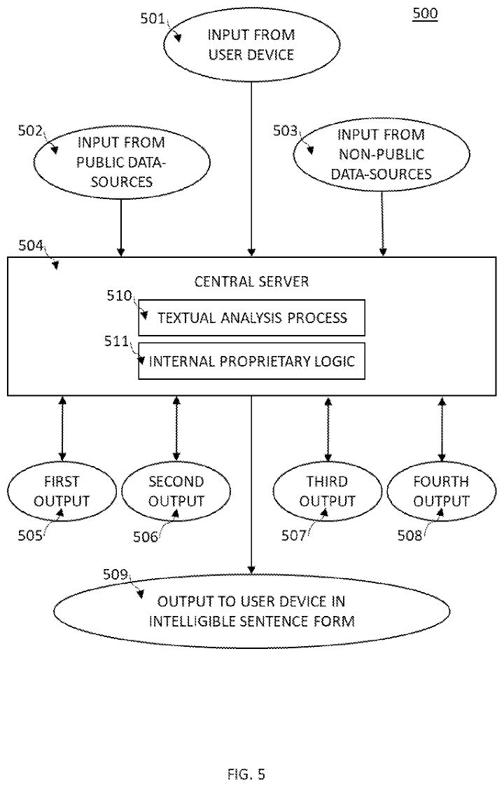

Lastly, as disclosed within FIG. 5, of the present subject matter, an essential-component block-diagram of the system and method of comparing real-estate data is disclosed. Specifically, FIG. 5 depicts a schematic view of the major components in an exemplary embodiment of a method 500 for executing upon request from a user, a comparison between the user desired property with all available real-estate data, in order to provide four distinct type of progressive-outputs, as described herein.

In any embodiment of the method of using the system for comparison of real-estate data 500, which comprises at least a central server 504 having a textual analysis process 510 and internal proprietary logic 511, that receives a user input 501, in the form of a desired property that is of interest to the user. The central server 504, initiates the process after it receives, an input from the user device 501, as described above. After receiving this input, the central server 504 obtains real-estate data as inputs from public data-sources 502 and non-public data-sources 503, as per requirement for its data-processing needs from time to time, relative to the progress of the method as performed by the system. The central server 504, upon processing of this data, as explained previously in the above embodiments, obtains/acquires a first output 505, a second output 506, a third output 507 and a fourth output 508. These four outputs are even used as inputs within some embodiments of the present subject matter, in order for further processing of all the real-estate data, obtained from the plurality of different real-estate data-sources. Lastly, all these four types of outputs are presented to the user, as an intelligible sentence-form 509. This ensures, that a user with very little technical experience may harness the power of computer-based data-processing, in order to gain deep unique insights regarding the desired property or real-estate unit, which would otherwise be impossible.

Effectuating the method and system, disclosed above, certain exemplary embodiments of user interactions, have been provided below:

For example, in one exemplary embodiment of the invention, where a user inputs a query to compare a specific real-estate property with very large glass face, that is made up of several windows. Once, the user input/query is received by the central server obtains data from a plethora of real-estate data sources such as, maintenance records, service request records, property purchase records (general ledgers, invoices), capital planning records, capital expenditure records, budget records, capex, internal reviews, online reviews and any hereby non-described record that pertains to the maintenance history of a particular property. Certain records that are obtained, such as, the service records may upto 5,000 or more pages, the general ledger may contain more than 10,000+ entries, and much of these records may not be available online or to the public easily. These general ledger records may also be utilised to establish the price/cost category of the real-estate property of interest. The central server then performs textual analysis process, followed by categorization by the internal proprietary logic, in order to process all the obtained data. Post processing, the internal proprietary logic in turn obtains a plurality of issue-categories, which are categorised along with the frequency of service orders within each of these issue-categories. The internal proprietary logic then proceeds to establish a plurality of average properties, which are essentially a virtual construct, generated purely based on the frequencies of service orders within each of the issue-categories, the price/cost category of the real-estate property and several other similar parameters. Each of these average properties is generated, based on the corresponding data obtained from the various real-estate data-sources that are accessible to the central server at the time of such execution. Then, the frequency of service orders for each of the issue category of the plurality of virtual average properties, are compared against the values of the user desired property, by the internal proprietary logic. After this comparison process is done, a plurality of comparative datasets is obtained by the internal proprietary logic, with respect to each of the average properties. The central server then provides, a first output to the user by representing all the recurring issue-categories, for each of these comparative datasets. These recurring issue-categories could be for instance, window issues, water remediation, plumbing, leaks in wall, etc.

Continuing with the forgoing example, in some preferred embodiments of the invention, the internal proprietary logic of the central server, continues to compare the obtained plurality of comparative datasets, with respect to each other, in order to identify all the overlaps within the recurring issue-categories. These overlapping recurring issue-categories are also, presented to the user as a second output. The overlaps in these categories could be for instance, recurrence of window issues and related wall leakage due to weathering, etc.

In continuance with the same example, in some other preferred embodiments of the invention, the internal proprietary logic of the central server, conducts an Engineering-Review of the overlapping recurring issue-categories, in order to determine one or more high-risk categories as a third output. In this step, the central server may in some instances even suggest/direct the administrator of the system, to conduct some level of manual-analysis (entails acquisition of fresh pictures, videos or physically visiting the property, etc.) of a certain real-estate property, after such a review process. Further, in some instances the internal proprietary logic, may provide a third output that, the Window issue is a high-risk issue-category, as there is 1 service request every 9.4 days, in addition to which, the issue occurred 79 more times (108% more) for the user desired property compared to the average property. Furthermore, in another instance it may present a third output as, review of these window-issue service requests shows no clear trends, hence we recommend further review by the due-diligence team lead who is onsite, to determine the next best steps. This may be determined by for instance, as follows:

Window units—The property reports replacements to a due-diligence team member who also visits and observes a percentage of the property. The data can show how much was spent on window units to provide supportive proof to the due-diligence team member of how many units were actually replaced. The due-diligence team member can then reference this data and provide a higher surety in his/her report.

Water Remediation—The property reports no known prior water remediation to a due-diligence team member, who also visits and observes a percentage of the site. The data can show how much was spent on water remediation to provide supportive proof to the due-diligence team member of prior leaks. The due-diligence team member can then reference this data and provide a higher surety in his report. Prior water remediation usually is not observable. If there are unreported issues, the due-diligence team/member can then follow-up directly with the property on an issue that was overlooked so that he can provide a higher surety in his report.

In further continuance with the same example, in some other preferable embodiments of the invention, the internal proprietary logic of the central server, analyses all the previous three outputs, in order to form an analysed-data of the user desired property. This analysed-data is then utilised by the internal proprietary logic to forecast/predict a very precise/accurate cost-estimate for conducting repairs/maintenance of this property in the future, as a fourth output.

Lastly, in continuance with the same example, in some final preferable embodiments of the invention, the internal proprietary logic of the central server, presents all these four outputs in a human-understandable intelligible sentence-form to the user, in order to provide critical information. This information cannot be obtained by the user easily online, which is further presented to the user in a simple clear form, such that it is understandable by a person having no technical knowledge of real-estate data.

While this specification contains many specific implementation details, these should not be construed as limitations on the scope of any implementations or of what may be claimed, but rather as descriptions of features specific to particular embodiments of particular implementations. Certain features that are described in this specification in the context of separate embodiments may also be implemented in combination in a single embodiment. Conversely, various features that are described in the context of a single embodiment may also be implemented in multiple embodiments separately or in any suitable sub-combination. Moreover, although features may be described above as acting in certain combinations and even initially claimed as such, one or more features from a claimed combination may in some cases be excised from the combination, and the claimed combination may be directed to a sub combination or variation of a sub combination.

Similarly, while methods/operations are depicted in the drawings in a particular order, this should not be understood as requiring that such operations be performed in the particular order shown or in sequential order, or that all illustrated operations be performed, to achieve desirable results. Moreover, only particular embodiments of the subject matter have been described, here. Other embodiments are within the scope of the following claims. In some cases, the actions recited in the claims is performed in a different order and still achieve desirable results. In addition, the processes depicted in the accompanying figures do not necessarily require the particular order shown, or sequential order, to achieve desirable results. Below provided are the claims pertaining, to the present subject matter:

1. A computer-implemented method for comparison of real-estate data, comprising the steps of:
a) Receiving inputs from a user with respect to a property, in order to obtain a real-estate data from a plurality of real-estate data-sources;
b) Processing the real-estate data, using a textual-analysis process followed by categorization with an internal proprietary logic, in order to obtain a plurality of issue-categories;
c) Calculating a frequency of service orders within each of the issue-categories;
d) Generating a plurality of comparative datasets, by comparing the frequency of service orders for each issue-category, of the said property, with respect to, an average property with similar attributes, wherein each of the average property is obtained from each of the plurality of real-estate data-sources;
e) Reviewing, all the recurring issue-categories, within each of the plurality of comparative datasets; and
f) Obtaining all the recurring issue-categories as a first output for the user.

2. The computer-implemented method for comparison of real-estate data, according to claim 1 further comprises the steps of:
Comparing, the first output obtained from one real-estate data-source, with respect to, the first output obtained from another real-estate data-source, in order to identify an overlap in the recurring issue-categories, obtained as a second output for the user.

3. The computer-implemented method for comparison of real-estate data, according to claim 2 further comprises the steps of:
Conducting an Engineering-Review of the recurring issue-categories as well as the identified overlaps in the recurring issue-categories, in order to determine, one or more issue-categories that are at high-risk, as a third output for the user.

4. The computer-implemented method for comparison of real-estate data, according to claim 3 further comprises the steps of:
analysing all the previous three outputs, in order to form an analysed-data; and
based on the analysed-data, predicting/forecasting a precise/accurate cost-estimate for conducting repairs/maintenance of the said property in the future, as a fourth output for the user.

5. The computer-implemented method for comparison of real-estate data, according to claim 4 further comprises the steps of:
presenting all the four outputs, in an intelligible sentence-form to the user.

6. The computer-implemented method for comparison of real-estate data, according to claim 1, wherein:
the real-estate data including the average property, is obtained from a plurality of real-estate data-sources, that are selected from the group consisting of various public/non-public data-sources, such as, building owners, general ledgers, capital plans, budgets, service order records/requests, online reviews, internal reviews, capex and any other such known real-estate data-sources.

7. The computer-implemented method for comparison of real-estate data, according to claim 1, wherein:
the plurality of issue categories, are selected from the group consisting of categories, such as relating to, roofing, walls, structures, plumbing, piping, air conditioning, electrical/fire related, window/glass related, appliances, any non-functioning amenity, any potential hazard, or any other similar real-estate issue, as known within the art.

8. The computer-implemented method for comparison of real-estate data, according to claim 1, wherein:
the plurality of issue categories, are processed by the internal proprietary logic, in order to obtain both typical as well as non-typical, types of issue-categories.

9. The computer-implemented method for comparison of real-estate data, according to claim 8, wherein:
the internal proprietary logic, reviews all the issue-categories obtained for any errors/mistakes;
in case errors/mistakes are identified, a correction to the issue-categories is made by the logic.

10. The computer-implemented method for comparison of real-estate data, according to claim 9, wherein:
the internal proprietary logic, determines a cause of error/mistake of the wrong categorisation instance;
based on this cause, it makes modifications to the internal proprietary logic itself; and
further re-calculation/re-calibration of the entire available real-estate data is once again conducted by the modified internal proprietary logic, to eliminate any previously overlooked errors.

11. The computer-implemented method for comparison of real-estate data, according to claim 1, wherein:
the textual-analysis process is applied on the obtained real-estate data, before the internal proprietary logic processes them into the plurality of issue categories;
wherein the textual-analysis process, identifies spelling-mistakes/abbreviations/truncations within the obtained real-estate data; and
predicts last-words and providing textual-solutions, for other identified textual-discrepancies within the obtained real-estate data, using Natural Language Models.

12. A computer-implemented system of comparing real-estate data using a central server, comprising the steps of:
a) Receiving inputs from a user device with respect to a property, in order to obtain a real-estate data from a plurality of real-estate data-sources;
b) Processing the real-estate data, using a textual-analysis process followed by categorization with an internal proprietary logic, in order to obtain a plurality of issue-categories;
c) Calculating a frequency of service orders within each of the issue-categories;
d) Generating a plurality of comparative datasets, by comparing the frequency of service orders for each issue-category, of the said property, with respect to, an average property with similar attributes, wherein each of the average property is obtained from each of the plurality of real-estate data-sources;
e) Reviewing, all the recurring issue-categories, within each of the plurality of comparative datasets; and
f) Obtaining all the recurring issue-categories as a first output for the user device.

13. The computer-implemented system of comparing real-estate data using a central server, according to claim 12 further comprises the steps of:
Comparing, the first output obtained from one real-estate data-source, with respect to, the first output obtained from another real-estate data-source, in order to identify an overlap in the recurring issue-categories, obtained as a second output for the user device.

14. The computer-implemented system of comparing real-estate data using a central server, according to claim 13 further comprises the steps of:
Conducting an Engineering-Review of the recurring issue-categories as well as the identified overlaps in the recurring issue-categories, in order to determine, one or more issue-categories that are at high-risk, as a third output for the user device.

15. The computer-implemented system of comparing real-estate data using a central server, according to claim 14 further comprises the steps of:
analysing all the previous three outputs, in order to form an analysed-data; and
based on the analysed-data, predicting/forecasting a precise/accurate cost-estimate for conducting repairs/maintenance of the said property in the future, as a fourth output for the user device.

16. The computer-implemented system of comparing real-estate data using a central server, according to claim 15 further comprises the steps of:
presenting all the four outputs, in an intelligible sentence-form to the user device.
